(19) United States
(12) Patent Application Publication
(10) Pub. No.: US 2020/0274996 A1
(43) Pub. Date: Aug. 27, 2020

(54) Method and Device for Detecting Bed Bugs

(71) Applicant: Brian Virag, Los Angeles, CA (US)

(72) Inventor: Brian Virag, Los Angeles, CA (US)

(21) Appl. No.: 16/281,089

(22) Filed: Feb. 21, 2019

(51) Int. Cl. H04N 5/225; G06K 9/22; A01M 1/02

(52) U.S. Cl. CPC H04N 5/2254; G06K 9/228; H04N 2005/2255; A01M 2200/011; A01M 1/026

(57) ABSTRACT

The present invention identifies bed bugs using a specially designed probing device designed to inspect the small, dark spaces between a mattress and box spring, under a bed and in small, narrow crevices of a bed or room where bed bugs are known to hide. The present invention captures an image of the inspected space with a camera, mirror and light component at the end of a probing unit and transmits the image to computing device for closer inspection and verification of the presence of a bed bug.

### FIELD OF THE INVENTION

This invention relates to an insect detection and monitoring method and device. This invention is particularly suited for detecting bed bugs.

### BACKGROUND

Cimex lectularius, or bed bugs as they are commonly known, are insects that feed on human blood and usually feed at night. Their bites can result in rashes, blisters or allergic reactions. These pests are highly undesirable and are hitchhiker insects that attach themselves to luggage and other belongings to move to new locations. Businesses, like hotels, go to great lengths to avoid the presence of bed bugs. If a hotel has a reputation for having bed bugs, business can be severely and negatively impacted.

Bed bugs are spread by being carried to new locations, typically on personal items like luggage. It is common for bed bugs to be found in hotels and other high-density areas. During the day, bed bugs hide in dark areas, like mattress seams and small cracks in nearby walls. Bed bugs feed at night and are attracted to their human hosts by body heat.

Infestations can grow rapidly. A single bed bug can result in 300 adults and 1,000 new eggs in as little as 3 months. Thus, it is imperative that the first signs of an infestation be identified so that extermination procedures can be promptly initiated.

To avoid a bed bug infestation, it is imperative to closely inspect sleeping accommodations for bed bugs prior to and following each use for signs of the pests.

It may be difficult to properly inspect the space around a mattress, headboard and box spring for bed bugs due to the small, dark nature of their preferred environment. Bed bugs hide in cracks and crevices to avoid detection.

Mature bed bugs are very similar in size and appearance to an apple seed or piece of lint. Young bed bugs are even smaller in size or lighter in color and are difficult to identify.

The present invention solves this problem.

### SUMMARY OF THE INVENTION

The present invention identifies bed bugs using a specially designed probing device designed to inspect small, dark spaces including the spaces surrounding a mattress, box spring, picture frames, night stands and other small, narrow cracks and crevices of a bed or room where bed bugs can be found. The present invention captures an image of the inspected space with a camera at the end of a probing unit and transmits the image to computing device for closer inspection and verification of the presence of a bed bug.

In one embodiment of the present invention, a camera is positioned at the end of a probe, for example an endoscope. The camera is utilized to capture images of bed bugs that infest the inspected bedding. The camera is equipped with a light and mirror feature for capturing clear images for transmission by the endoscope to a computing device, for example a smart phone. Captured images can be used to confirm the presence of a bed bug infestation.

The present invention also discloses a method of using the described device for inspecting bedding for bed bugs.

### BRIEF DESCRIPTION OF DRAWINGS

FIG. 1 discloses one embodiment of the present invention 101. The USB end 105 is for attachment to a computing device. A connecting wire 104, connects the USB end to an endoscope in a retracted position 103 and a shark fin attachment 102 containing a light and mirror component for capturing images of a bed bug.

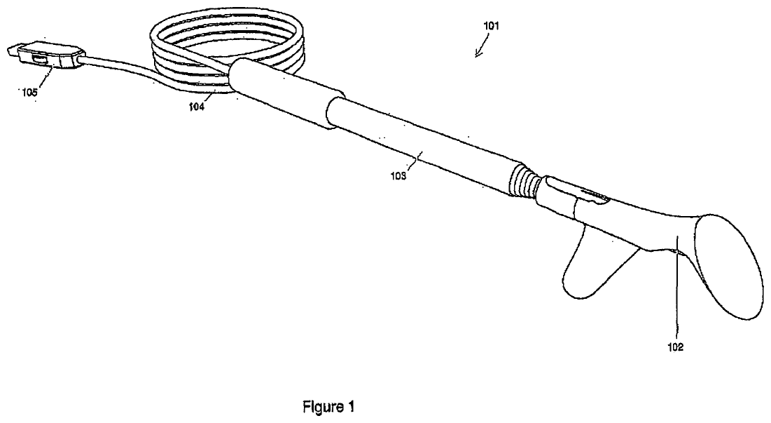

FIG. 2 discloses one embodiment of the present invention comprising a USB end 105 for attachment to a computing device, a connecting wire 104, an endoscope in an extended position 103 and a shark fin attachment 102 containing a light and mirror component.

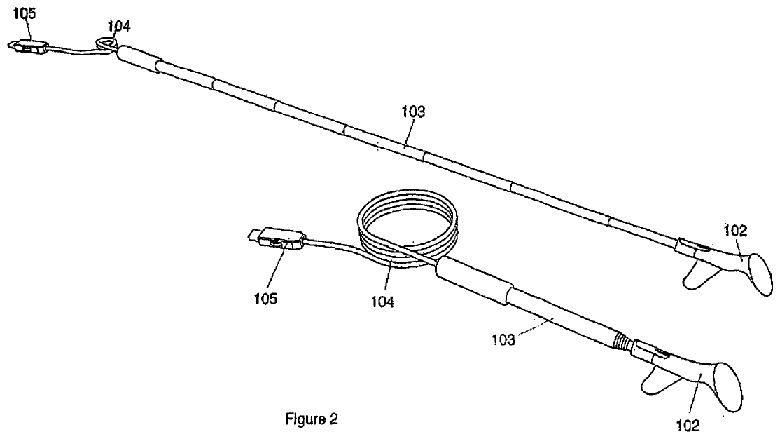

FIG. 3 discloses the camera end of the probing devices 103 with the shark fin attachment connected 102, the shark fin attachment comprises a mirror component 302 and a light component 301.

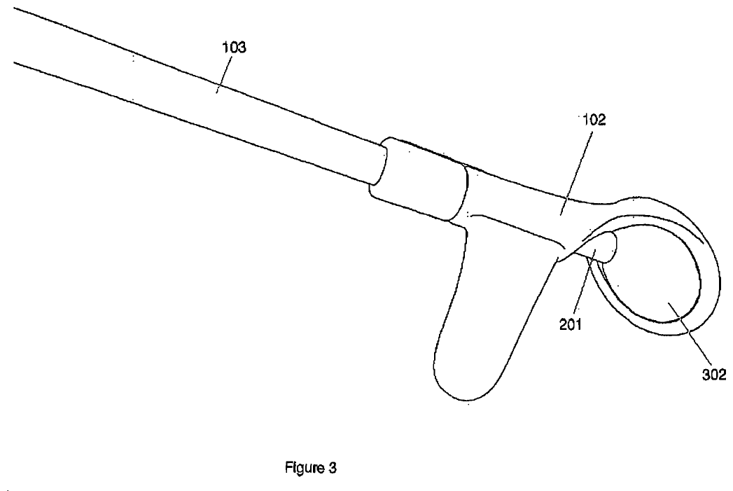

FIG. 4 discloses the camera end 201 of the probing device 103 with the shark fin 301 attachment 102 detached.

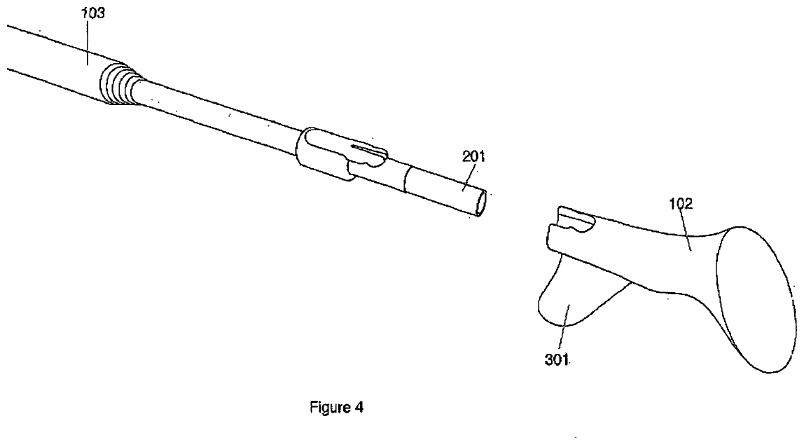

### DETAILED DESCRIPTION OF THE INVENTION

As used herein, the words or terms used herein have the following definitions:

A bed bug is a member of the Cimex lectularius species of insects that feed on human blood. It is a wingless hemipterous bug that is known to infest human dwellings.

An endoscope is an illuminated, ridged tubular instrument for inspection of bed bugs in a specified area.

A computing device is a smart phone, tablet, PC or other device that can receive image transmissions from a camera for inspection of bed bugs in a specified area.

A camera is a device that consists of a lightproof chamber with an aperture fitted with a lens and a shutter through which the image of an object is projected onto a surface for recording or for translation into electrical impulses.

A mirror is a polished, smooth surface that forms images by reflection.

A shark fin is a removable attachment for placement at the camera end of the present invention. It is designed to capture images on the mirror component of the invention for reflection onto the camera component of the invention so that images are not too far from or close to the camera and clear images may be captured. A light component allows the image to be viewed on the mirror component and reflected on to the camera component.

An examiner is the person using the disclosed invention.

In one embodiment of the present invention, the device comprises an endoscope for capturing images of an inspected space.

In another embodiment of the present invention, the device further comprises a light component that is used to illuminate dark spaces for better inspection. In a preferred embodiment, the light is an LED light.

In another embodiment of the present invention, the device further comprises a mirror component. The mirror component is used to reflect images from an inspected surface for capture by the camera component.

In another embodiment of the present invention, the mirror and/or light components of the device may comprise a removable “shark fin” component. The shark fin component attaches to the camera end of the endoscope for capturing clear images of a bed bug in an inspected space. The image is captured at the optimal distance from the camera lens for viewing and transmission.

In one embodiment of the present invention, the endoscope includes a telescoping feature, which allows the user to access spaces that are difficult to reach by the examiner. For example, it may be difficult for an examiner to crawl under a bed to inspect the middle of a box spring. Using the telescoping feature of the present invention, the camera end of the endoscope can reach the middle of a box spring for inspection and images of the space can be captured by the camera for transmission to a computing device.

The endoscope may also be used in a retracted position for inspection of small spaces near the examiner.

In one embodiment of the present invention, images captured by the camera are transmitted to a receiving device. A smart phone is a device commonly used by consumers; it is a preferred embodiment of the present invention that the computing device be a smart phone.

However, it is contemplated that a receiving device can be a smart phone, a tablet, a computer or other device that can be used to capture images transmitted by the camera.

In one embodiment of the present invention, the endoscope is attached to a computing device via USB connection.

In another embodiment, transmission from the camera to the computing device occurs wirelessly.

The present invention also discloses a method for detecting bed bugs using the apparatus disclosed herein. In one embodiment of the present invention, the endoscope is attached to a smartphone using a USB port. The endoscope is elongated so that the telescoping feature is enabled. The light attached to the endoscope is turned on. The examiner places the camera end of the endoscope against the area to be searched, including spaces between a mattress and a box spring, under a bed, behind a headboard and small cracks in the area surrounding the sleeping area. Images of the inspected space are captured and transmitted to a computing device. Where the transmitted image discloses a bed bug, the presence of a bed bug infestation in the inspected space is confirmed.

In another embodiment of the present invention, a software program or app on the computing device is used to guide inspection, instruct the examiner, capture images, save images, and/or transmit images to another device.

1. An apparatus for inspecting for bed bugs, the apparatus comprising;
an endoscope; and
a computing device.

2. The apparatus disclosed in claim 1, further comprising a mirror.

3. The apparatus disclosed in claim 1, further comprising a light.

4. The apparatus disclosed in claim 1, further comprising a light and a mirror.

5. The apparatus disclosed in claim 1, further comprising a telescoping handle.

6. An apparatus for detecting bed bugs, the devise comprising;
a light component;
a camera component; and
a telescoping handle for transmission of an image captured by the camera component to a receiving device.

7. The apparatus disclosed in claim 1, further comprising a removable shark fin attachment

8. A method for detecting bed bugs using the device described in claim 1, the method comprising:
linking the device to a smart phone;
inspecting a bed for bed bugs; and
capturing images of an infestation with the device.

9. The method described in claim 8, further comprising a software application for Inspecting capturing and reporting bed bug infestations.
